(19) United States
(12) Patent Application Publication
(10) Pub. No.: US 2023/0070847 A1
(43) Pub. Date: Mar. 9, 2023

(54) SYSTEM AND METHOD FOR PLANNING A DATA WAREHOUSE MIGRATION

(71) Applicant: DATAMETICA SOLUTIONS PVT LTD, PUNE (IN)

(72) Inventors: NIRAJ KUMAR, PUNE (IN); ABBAS GADHIA, PUNE (IN); ABHISHEIK PUSHP, PUNE (IN)

(21) Appl. No.: 17/810,849

(22) Filed: Jul. 6, 2022

(30) Foreign Application Priority Data
Sep. 3, 2021 (IN) 202121040027

(51) Int. Cl. G06F 16/21; G06F 16/25; G06F 16/28

(52) U.S. Cl. CPC G06F 16/214; G06F 16/254; G06F 16/283

(57) ABSTRACT

A system for planning a data warehouse migration is provided. The system includes an extraction module 40 which extracts specific data from a data warehouse in a form of files upon registering a data warehouse owner on a centralized platform via a device. The system also includes a processing module 50 which processes the files using a processing technique to identify features of the data warehouse. The system also includes a migration planning module 60 which generates clusters of objects using a clustering technique, wherein the objects within at least one of the clusters are migrated together as the corresponding objects are related to each other with a first predefined relationship and generates a migration order according to which the objects are to be migrated based on one of the clusters generated, a second predefined relationship between the clusters generated, or a combination thereof, thereby planning the data warehouse migration.

### EARLIEST PRIORITY DATE

This International Application claims priority from a complete patent application filed in India having Patent Application No. 202121040027, filed on Sep. 3, 2021 and titled “SYSTEM AND METHOD FOR PLANNING A DATA WAREHOUSE MIGRATION”

### FIELD OF INVENTION

Embodiments of a present invention relate to planning migration of data warehouse, and more particularly, to a system and method for planning a data warehouse migration.

### BACKGROUND

Data warehouse migration is a migration of the data warehouse such that upon successful migration of the data warehouse, the data warehouse runs fast or faster and at a lower cost than the legacy system, the data warehouse was migrated from. A first step towards the data warehouse migration includes making a strategy or a plan for the migration. In a traditional approach, the data warehouse migration is carried out by exploiting human resource talent for planning which requires a significant investment on the human resource as the data to be migrated is in large amount and human resource requirement would also be large. Also, as human workers are involved in the planning of the migration, the migration may be vulnerable to human errors. Further, the data warehouse migration may also be dependent on available documentation and constraints to be applied to finalize the strategy or the plan. However, this is error-prone as over a period of time, the documents may not be in sync with the actual queries executed in real-time, thereby making such an approach less reliable, less efficient, and time-consuming.

Hence, there is a need for an improved system and method for planning a data warehouse migration which addresses the aforementioned issues.

### BRIEF DESCRIPTION

In accordance with one embodiment of the disclosure, a system for planning a data warehouse migration is provided. The system includes one or more processors. The system also includes an extraction module operable by the one or more processors. The extraction module is configured to extract specific data from a data warehouse in a form of one or more files upon registering a data warehouse owner on a centralized platform via a device. The specific data extracted includes one of one or more database logs, one or more data models, and a data dictionary related to one or more databases in the data warehouse, one or more Extract, Transform and Load (ETL) tools, information related to one or more sources and one or more consumers of each of the one or more databases in the data warehouse, or a combination thereof. The data warehouse is to be migrated from a first location to a second location. Further, the system also includes a processing module operable by the one or more processors. The processing module is configured to process the one or more files including the specific data extracted using a processing technique to identify one or more features of the data warehouse. Furthermore, the system also includes a migration planning module operable by the one or more processors. The migration planning module is configured to generate one or more clusters of one or more objects using a clustering technique upon identifying the one or more features of the data warehouse, wherein the data warehouse includes the one or more objects. The one or more objects within at least one of the one or more clusters are migrated together as the corresponding one or more objects are related to each other with a first predefined relationship. The migration planning module is also configured to generate a migration order according to which the one or more objects are to be migrated based on one of the one or more clusters generated, a second predefined relationship between the one or more clusters generated, or a combination thereof, thereby planning the data warehouse migration.

In accordance with another embodiment, a method for planning a data warehouse migration is provided. The method includes extracting specific data from a data warehouse in a form of one or more files upon registering a data warehouse owner on a centralized platform via a device, wherein the data warehouse is to be migrated from a first location to a second location. The method also includes processing the one or more files including the specific data extracted using a processing technique for identifying one or more features of the data warehouse. Further, the method also includes generating one or more clusters of the one or more objects using a clustering technique upon identifying the one or more features of the data warehouse, wherein the data warehouse comprises the one or more objects, wherein the one or more objects within at least one of the one or more clusters are migrated together as the corresponding one or more objects are related to each other with a first predefined relationship. Furthermore, the method also includes generating a migration order according to which the one or more objects are to be migrated based on one of the one or more clusters generated, a second predefined relationship between the one or more clusters generated, or a combination thereof, thereby planning the data warehouse migration.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for planning a data warehouse migration in accordance with an embodiment of the present disclosure;

FIG. 2 is a block diagram representation of an exemplary embodiment of the for planning the data warehouse migration of FIG. 1 in accordance with an embodiment of the present disclosure:

FIG. 3 is a block diagram of a migration planner computer or a migration planner server in accordance with an embodiment of the present disclosure; and

FIG. 4 is a flow chart representing steps involved in a method for planning a data warehouse migration in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

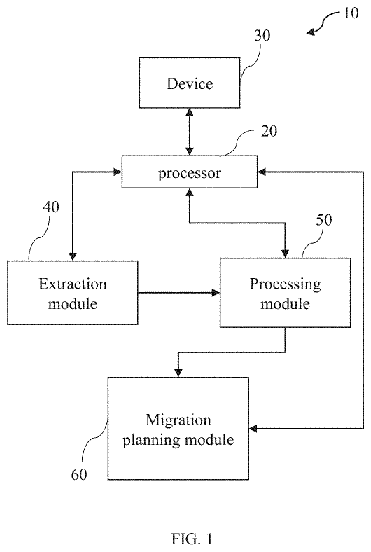

Embodiments of the present disclosure relate to a system for planning a data warehouse migration. As used herein, the term “data warehouse” is defined as an information system that contains historical data and commutative data from a single source or multiple sources and is used for reporting and data analysis. Further, as used herein, the term “data warehouse migration” is defined as a migration of the data warehouse from a first location to a second location such that upon successful migration of the data warehouse, the data warehouse runs fast or faster and at a lower cost than the legacy system, the data warehouse was migrated from. Thorough planning may have to be done to execute the data warehouse migration successfully. Thus, the system described hereafter in FIG. 1 is the system for planning the data warehouse migration.

FIG. 1 is a block diagram representation of a system 10 for planning a data warehouse migration in accordance with an embodiment of the present disclosure. The system 10 includes one or more processors 20. In an embodiment, the system 10 herein represents a centralized platform. In one embodiment, the system 10 may be stored in a server. In such embodiment, the server may include one of a local server and a cloud server. An organization may be willing to migrate a data warehouse of the organization from a first location to a second location due to one or more reasons. In one embodiment, the first location may include a first local server located at a first geographic location of the corresponding organization, a first cloud server linked to the corresponding organization, a first system, or the like. In one embodiment, the second location may include a second local server located at a second geographic location of the corresponding organization where the organization may have to be moved, a second cloud server linked to the corresponding organization, a second system, or the like. In one embodiment, the one or more reasons may include changing the geographic location of the organization itself, to run the data warehouse faster, to run the data warehouse faster at a lower cost, or the like.

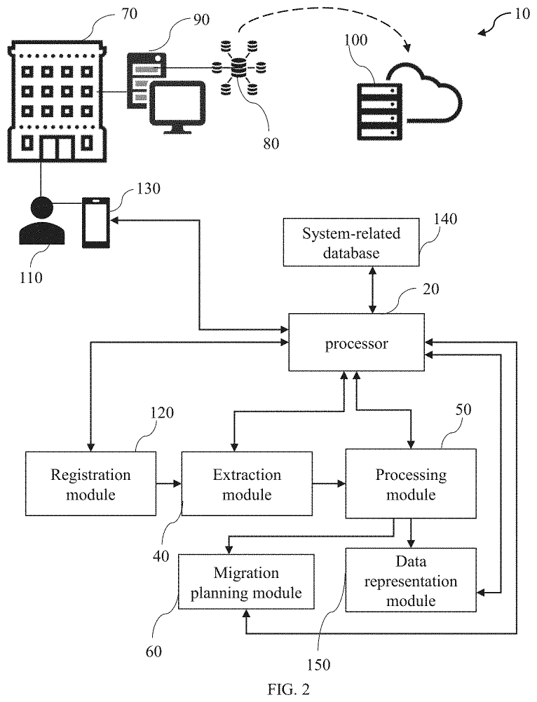

Further, for the organization to be able to perform the data warehouse migration using the system 10, an owner of the organization may have to register on the centralized platform. In an embodiment, the owner of the organization may also be the owner of the data warehouse. Thus, the system 10 also includes a registration module (as shown in FIG. 2) operable by the one or more processors 20. The registration module may be configured to register a data warehouse owner on the centralized platform upon receiving a plurality of data warehouse owner related details via a device 30. In one embodiment, the plurality of data warehouse owner related details may include a data warehouse owner name, an organization name, data warehouse owner contact details, and the like. In one exemplary embodiment, the plurality of data warehouse owner related details may be stored in a system-related database (as shown in FIG. 2). In one embodiment, the system-related database may include one of a local database and a cloud database. Further, in an embodiment, the device 30 may include a mobile phone, a tablet, a laptop, or the like.

Further, in order to plan the data warehouse migration, specific data may have to be extracted from the data warehouse. Thus, the system 10 also includes an extraction module 40 operable by the one or more processors 20. The extraction module 40 may be operatively coupled to the registration module. The extraction module 40 is configured to extract the specific data from the data warehouse in a form of one or more files upon registering the data warehouse owner on the centralized platform via the device 30.

In one embodiment, the extraction module 40 may be configured to extract the specific data using an extraction technique. In one exemplary embodiment, the extraction technique may include performing a set of instructions such that one or more commands may have to be sent to the data warehouse, which is to be migrated, thereby extracting the specific data. The data warehouse is to be migrated from the first location to the second location.

Further, the specific data extracted includes one of one or more database logs, one or more data models, and a data dictionary related to one or more databases in the data warehouse, one or more Extract, Transform and Load (ETL) tools, information related to one or more sources and one or more consumers of each of the one or more databases in the data warehouse, and the like, or a combination thereof. As used herein, the term “database log” is defined as a fundamental component of a database management system (DBMS) which is also termed as a transaction log. All the changes made to the data in a database are recorded serially in the database log. Using this information, the DBMS can track which transaction made which changes to the database.

Further, as used herein, the term “database” is defined as an organized collection of data, generally stored and accessed electronically from a computer system. The database may include multiple objects, wherein the multiple objects may include tables, indexes, views, clusters, sequences, stored procedures, and the like. The multiple objects may also have different fields. Further, as used herein, the term “data model” is defined as a model that defines how the logical structure of a database is modeled.

Furthermore, as used herein, the term “data dictionary” is defined as a centralized repository of information about data such as meaning, relationships to other data, origin, usage, and format. The data dictionary is also termed as a metadata repository. Further, as used herein, the term “ETL tool” is defined as a tool used to collect, read, and migrate large volumes of raw data from multiple data sources and across disparate platforms. The ETL tool basically provides information about the flow of data between the one or more databases. Moreover, the one or more sources may be defined as an entity where data may be created, and the one or more consumers may be defined as an entity that uses the data created. In one exemplary embodiment, the ETL tool may be related to and internal to the corresponding data warehouse to be migrated. In another exemplary embodiment, the ETL tool may be external to the corresponding data warehouse to be migrated and also related to the data warehouse.

Subsequently, in one embodiment, the extraction module 40 may also be configured to extract the specific data from a reporting tool, a scheduler, and the like, related to the data warehouse. As used herein, the term “reporting tool” is defined as a tool that produces one or more reports based on a specified data, as well as applies different filters, parameters, and output formats to the results. The reporting tool generates data based on the transfer of data from a production database to the data warehouse where it is stored in data sets. Thus, in one embodiment, the specific data extracted from the reporting tool may include the one or more reports in one or more forms such as, but not limited to, an area graph, a bar graph, a line graph, a pie graph, a preview table, and the like. In one exemplary embodiment, the one or more reports extracted may be stored in the system-related database.

As used herein, the term “scheduler” is defined as a tool that is used to control when and where various tasks take place in the database environment. The scheduler helps to improve the management and planning of these tasks. Thus, in one embodiment, the specific data extracted from the scheduler may include information regarding time when one or more tasks are performed. In one exemplary embodiment, the specific data extracted from the scheduler may also be stored in the system-related database.

Furthermore, the specific data extracted including one or more object definitions and one or more queries executed on the one or more objects in the one or more databases of the data warehouse to be migrated may have to be processed to identify one or more features of the data warehouse so that, the data may be segregated, thereby easing a process of the data warehouse migration. Thus, the system 10 also includes a processing module 50 operable by the one or more processors 20. The processing module 50 is operatively coupled to the extraction module 40. The processing module 50 is configured to process the one or more files including the specific data extracted using a processing technique to identify the one or more features of the data warehouse. In one embodiment, the processing technique may include at least one framework, wherein the at least one framework may include at least one of Big Data, Hadoop, Apache Spark, and the like. As used herein, the term “Big Data” is defined as a field that covers ways to analyze, systematically extract information from, or otherwise deal with data sets that are too large or complex to be dealt with by traditional frameworks.

As used herein, the term “Hadoop” is defined as a type of Big Data framework which allows distributed processing of large data sets across clusters of computers using simple models and provides massive storage for any kind of data. Further, as used herein, the term “Apache Spark” is defined as a data processing framework that can quickly perform processing tasks on very large data sets and can also distribute data processing tasks across multiple computers, either on its own or in tandem with other distributed computing tools.

In one embodiment, the one or more features include one of a dataflow lineage within each of the one or more databases and between the one or more databases, access pattern of the one or more objects in each of the one or more databases, one or more events implemented on the corresponding one or more objects, or a combination thereof.

Basically, as used herein the dataflow lineage may provide information about a direction of flow of the data stored among the one or more databases, among the one or more objects, among one or more columns of the one or more objects, or the like. Also, the dataflow lineage may provide information about a link between the one or more objects. Further, as used herein the access pattern may provide information about who is accessing the data from which of the one or more objects, who is accessing the data from which of the one or more columns of the one or more objects, how many times the one or more objects have been accessed by at least one of the one or more users, and the like. In one embodiment, the one or more events may include one of one or more users interacting with the data stored in the one or more databases of the data warehouse, the one or more objects which may have participated in the execution of the one or more queries, mapping the one or more users to the corresponding one or more objects with which the respective one or more users may be interacting, and the like. The interaction may include reading the data, writing the data, copying the data, transferring data, or the like.

Furthermore, upon identifying the one or more features of the data warehouse, the one or more objects may have to be segregated forming one or more clusters based on the one or more features identified. Thus, the system 10 also includes a migration planning module 60 operable by the one or more processors 20. The migration planning module 60 is operatively coupled to the processing module 50. The migration planning module 60 is configured to generate the one or more clusters of the one or more objects using a clustering technique upon identifying the one or more features of the data warehouse, wherein the data warehouse includes the one or more objects. As used herein, the term “clustering technique” is defined as a technique including a set of join relationships and clustering instructions to be executed so that, the one or more objects which are linked with each other with a predefined relationship are grouped or clustered together.

Further, the one or more objects within at least one of the one or more clusters are migrated together as the corresponding one or more objects are related to each other with a first predefined relationship. In one embodiment, the first predefined relationship may include one of the one or more objects being similar, an application of the one or more objects being similar, the one or more events implemented on the one or more objects being similar, and the like, or a combination thereof. For example, the one or more objects accessed by a first user of the one or more users may be clustered together, the one or more objects which are not accessed for a long period may be clustered together, one or more objects or the one or more columns having data related to a particular application may be clustered together, or the like.

Moreover, upon clustering, an order according to which the one or more objects may have to be migrated is supposed to be planned. Thus, the migration planning module 60 is also configured to generate a migration order according to which the one or more objects are to be migrated based on one of the one or more clusters generated, a second predefined relationship between the one or more clusters generated, or a combination thereof, thereby planning the data warehouse migration. In one embodiment, the second predefined relationship may include one of the one or more clusters generated being dependent on each other, the one or more clusters sharing a common source, the one or more clusters sharing a common destination, and the like, or a combination thereof.

Further, in one embodiment, the migration planning module 60 may also be configured to enable a user to modify the migration order generated based on one or more parameters. In one embodiment, the user may include an individual responsible for the data warehouse migration, the data warehouse owner, or the like. Further, in one exemplary embodiment, the one or more parameters may include one of one or more un-recorded activities, one or more professional decisions, one or more personal decisions, and the like, or a combination thereof. Further, upon planning the data warehouse migration, the plan may be used for the migration of the data warehouse from the first location to the second location.

Further, in one embodiment, upon identifying the one or more features of the data warehouse, the one or more features may have to be represented such that the clustering of the one or more objects for the migration may become easy. Thus, in an embodiment, the system 10 may also include a data representation module (as shown in FIG. 2) operable by the one or more processors 20. The data representation module may be operatively coupled to the processing module 50. The data representation module may be configured to represent the one or more features identified of the data warehouse in a graphical representation. In one embodiment, the graphical representation may include one or more nodes, wherein the one or more nodes may represent one of the one or more users, the one or more objects, the one or more columns, the one or more databases, and the like, or a combination thereof.

FIG. 2 is a block diagram representation of an exemplary embodiment of the system (10) for planning the data warehouse migration of FIG. 1 in accordance with an embodiment of the present disclosure. The system 10 includes the one or more processors 20. Suppose as an organization ‘A’ 70 is planning to migrate a data warehouse ‘X’ 80 of the organization ‘A’ 70 from a local server 90 of the organization ‘A’ 70 to a cloud server ‘W’ 100 so that the data warehouse ‘X’ 80 runs faster at a lower cost in the cloud server ‘W’ 100. Now the organization ‘ A’ 70 needs to make a strategy or a plan to do so and hence an owner ‘Y’ 110 of the organization ‘A’ 70 plans of using the system 10 for planning the data warehouse migration.

Thus, in order to use the system 10, the owner ‘Y’ 110 registers on the centralized platform via the registration module 120 of the system 10 upon providing a plurality of owner details via an owner mobile phone 130. The plurality of owner details is stored in the system-related database 140 of the system 10. Later, upon registration, the system 10 extracts the specific data needed to plan for the data warehouse migration in the form of the one or more files via the extraction module 40 of the system 10.

Further, upon extracting the specific data, the one or more files are processed via the processing module 50 of the system 10 to identify the one or more features of the data warehouse ‘X’ 80. Later, upon identifying the one or more features, the one or more features are represented in the graphical representation by the data representation module 150 of the system 10, so that the clustering of the one or more objects based on the one or more features identified becomes easy. Further, the one or more clusters of the or more objects are generated by the migration planning module 60 of the system 10, wherein the one or more objects within at least one of the one or more clusters are migrated together as the corresponding one or more objects are related to each other. Lastly, the migration order is generated by the migration planning module 60 according to which the one or more objects are to be migrated, thereby planning the data warehouse migration of the data warehouse ‘X’ 80 of the organization ‘A’ 70 from the local server 90 to the cloud server ‘W’ 100.

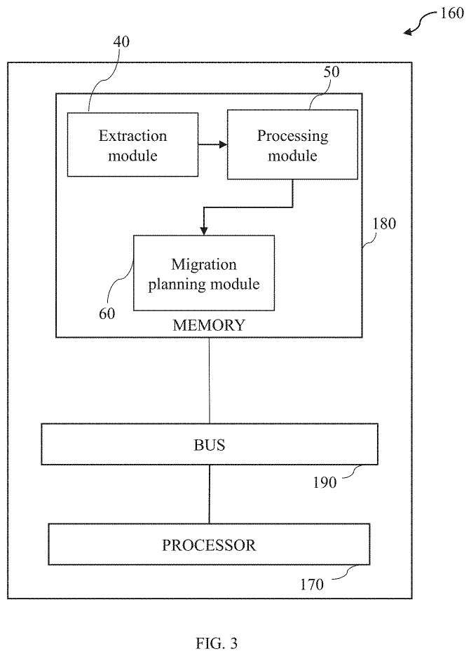

FIG. 3 is a block diagram of a migration planner computer or a migration planner server 160 in accordance with an embodiment of the present disclosure. The migration planner server 160 includes processor(s) 170, and a memory 180 coupled to a bus 190. As used herein, the processor(s) 170 and the memory 180 are substantially similar to the system 10 of FIG. 1. Here, the memory 180 is located in a local storage device.

The processor(s) 170, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 170.

The memory 180 includes a plurality of modules stored in the form of executable program which instructs the processors 170 to perform method steps illustrated in FIG. 3. The memory 180 has following modules: an extraction module (40), a processing module 50, and a migration planning module 60.

The extraction module 40 is configured to extract specific data from a data warehouse in a form of one or more files upon registering a data warehouse owner on a centralized platform via a device 30. The specific data extracted includes one of one or more database logs, one or more data models, and a data dictionary related to one or more databases in the data warehouse, one or more Extract, Transform and Load (ETL) tools, information related to one or more sources and one or more consumers of each of the one or more databases in the data warehouse, or a combination thereof. The data warehouse is to be migrated from a first location to a second location

The processing module 50 is configured to process the one or more files comprising the specific data extracted using a processing technique to identify one or more features of the data warehouse.

The migration planning module 60 is configured to generate one or more clusters of one or more objects using a clustering technique upon identifying the one or more features of the data warehouse, wherein the data warehouse includes the one or more objects. The one or more objects within at least one of the one or more clusters are migrated together as the corresponding one or more objects are related to each other with a first predefined relationship.

The migration planning module 60 is also configured to generate a migration order according to which the one or more objects are to be migrated based on one of the one or more clusters generated, a second predefined relationship between the one or more clusters generated, or a combination thereof, thereby planning the data warehouse migration.

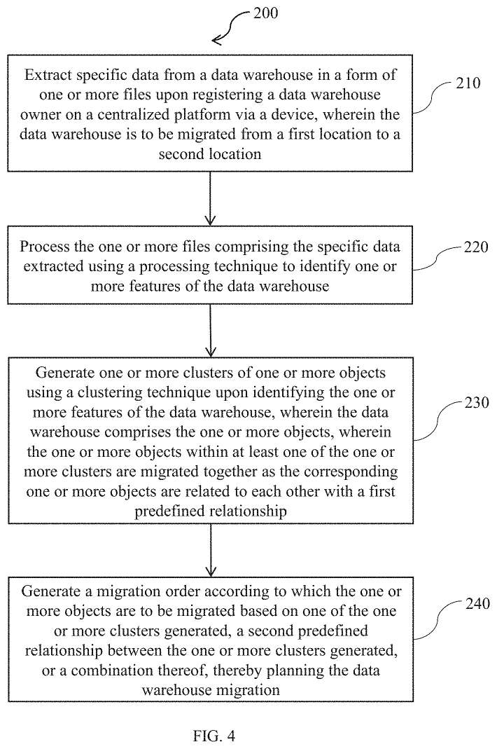

FIG. 4 is a flow chart representing steps involved in a method 200 for planning a data warehouse migration in accordance with an embodiment of the present disclosure. The method 200 includes extracting specific data from a data warehouse in a form of one or more files upon registering a data warehouse owner on a centralized platform via a device, wherein the data warehouse is to be migrated from a first location to a second location in step 210. In one embodiment, extracting the specific data from the data warehouse includes extracting the specific data from the data warehouse by an extraction module 40.

In one exemplary embodiment, extracting the specific data includes extracting one of one or more database logs, one or more data models, and a data dictionary related to one or more databases in the data warehouse, one or more Extract, Transform and Load ETL tools, information related to one or more sources and one or more consumers of each of the one or more databases in the data warehouse, and the like, or a combination thereof.

The method 200 also includes processing the one or more files including the specific data extracted using a processing technique for identifying one or more features of the data warehouse in step 220. In one embodiment, processing the one or more files includes processing the one or more files by a processing module 50.

In one exemplary embodiment, identifying the one or more features includes identifying one of a dataflow lineage within each of the one or more databases and between the one or more databases, access pattern of one or more objects of each of the one or more databases, one or more events implemented on the corresponding one or more objects, and the like, or a combination thereof.

Furthermore, the method 200 includes generating one or more clusters of the one or more objects using a clustering technique upon identifying the one or more features of the data warehouse, wherein the data warehouse includes the one or more objects, wherein the one or more objects within at least one of the one or more clusters are migrated together as the corresponding one or more objects are related to each other with a first predefined relationship in step 230. In one embodiment, generating the one or more clusters of the one or more objects includes generating the one or more clusters of the one or more objects by a migration planning module 60.

Furthermore, the method 200 includes generating a migration order according to which the one or more objects are to be migrated based on one of the one or more clusters generated, a second predefined relationship between the one or more clusters generated, or a combination thereof, thereby planning the data warehouse migration in step 240. In one embodiment, generating the migration order includes generating the migration order by the migration planning module 60.

Further, from a technical effect point of view, the implementation time required to perform the method steps included in the present disclosure by the one or more processors of the system is very minimal, thereby the system maintains very minimal operational speed.

Various embodiments of the present disclosure enable the planning of the data warehouse migration easily as the system is used for doing so and less prone to error as least human intervention is involved while planning. Also, the system is more efficient in terms of time and the planning of the data warehouse migration, as the system provided comprehensive analysis at a granular level of the data warehouse to be migrated.

Further, implementing granular level assessment, complex data warehouses are classified into logical chunks and related dependencies are highlighted which helps in formulating a powerful migration strategy with a systematic timeline. Also, the graphical representation provides a holistic view of the complex data warehouses and related dependencies. Further, the system executes the one or more queries, infers more accurate information, and stores the information in a more structured form, which further eases the process of planning for the system. Also, freedom for the user to modify the migration order generated by the system makes the system flexible use and provides interactive planning of the data warehouse migration, thereby making the system more reliable and more efficient.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for planning a data warehouse migration, wherein the system comprises:
one or more processors:
an extraction module operable by the one or more processors, wherein the extraction module is configured to extract specific data from a data warehouse in a form of one or more files upon registering a data warehouse owner on a centralized platform via a device,
wherein the specific data extracted comprises one of one or more database logs, one or more data models, and a data dictionary related to one or more databases in the data warehouse, one or more Extract, Transform and Load ETL tools, information related to one or more sources and one or more consumers of each of the one or more databases in the data warehouse, or a combination thereof, wherein the data warehouse is to be migrated from a first location to a second location;
a processing module operable by the one or more processors, wherein the processing module is configured to process the one or more files comprising the specific data extracted using a processing technique to identify one or more features of the data warehouse; and
a migration planning module operable by the one or more processors, wherein the migration planning module is configured to:
generate one or more clusters of one or more objects using a clustering technique upon identifying the one or more features of the data warehouse, wherein the data warehouse comprises the one or more objects, wherein the one or more objects within at least one of the one or more clusters are migrated together as the corresponding one or more objects are related to each other with a first predefined relationship; and
generate a migration order according to which the one or more objects are to be migrated based on one of the one or more clusters generated, a second predefined relationship between the one or more clusters generated, or a combination thereof, thereby planning the data warehouse migration.

2. The system as claimed in claim 1, wherein the one or more features comprise one of a dataflow lineage within each of the one or more databases and between the one or more databases, access pattern of the one or more objects in each of the one or more databases, one or more events implemented on the corresponding one or more objects, or a combination thereof.

3. The system as claimed in claim 1, wherein the first predefined relationship comprises one of the one or more objects being similar, an application of the one or more objects being similar, the one or more events implemented on the one or more objects being similar, or a combination thereof.

4. The system as claimed in claim 1, comprises a data representation module operable by the one or more processors, wherein the data representation module is configured to represent the one or more features identified of the data warehouse in a graphical representation.

5. The system as claimed in claim 1, wherein the migration planning module (60) is configured to enable a user to modify the migration order generated based on one or more parameters.

6. The system as claimed in claim 5, wherein the one or more parameters comprise one of one or more un-recorded activities, one or more professional decisions, one or more personal decisions, or a combination thereof.

7. The system as claimed in claim 1, wherein the second predefined relationship comprises one of the one or more clusters generated being dependent on each other, the one or more clusters sharing a common source, the one or more clusters sharing a common destination, or a combination thereof.

8. A method for planning a data warehouse migration, wherein the method comprises:
extracting, by an extraction module, specific data from a data warehouse in a form of one or more files upon registering a data warehouse owner on a centralized platform via a device, wherein the data warehouse is to be migrated from a first location to a second location;
processing, by a processing module, the one or more files comprising the specific data extracted using a processing technique for identifying one or more features of the data warehouse;
generating, by a migration planning module, one or more clusters of the one or more objects using a clustering technique upon identifying the one or more features of the data warehouse, wherein the data warehouse comprises the one or more objects, wherein the one or more objects within at least one of the one or more clusters are migrated together as the corresponding one or more objects are related to each other with a first predefined relationship; and
generating, by the migration planning module, a migration order according to which the one or more objects are to be migrated based on one of the one or more clusters generated, a second predefined relationship between the one or more clusters generated, or a combination thereof, thereby planning the data warehouse migration.

9. The method as claimed in claim 8, wherein extracting the specific data comprises extracting one of one or more database logs, one or more data models, and a data dictionary related to one or more databases in the data warehouse, one or more Extract, Transform and Load ETL tools, information related to one or more sources and one or more consumers of each of the one or more databases in the data warehouse, or a combination thereof.

10. The method as claimed in claim 8, wherein identifying the one or more features comprises identifying one of a dataflow lineage within each of the one or more databases and between the one or more databases, access pattern of one or more objects of each of the one or more databases, one or more events implemented on the corresponding one or more objects, or a combination thereof.
